(19) United States
(12) Patent Application Publication
(10) Pub. No.: US 2024/0022950 A1
(43) Pub. Date: Jan. 18, 2024

(54) DECENTRALIZED COORDINATED REINFORCEMENT LEARNING FOR OPTIMIZING RADIO ACCESS NETWORKS

(71) Applicant: Telefonaktiebolaget LM Ericsson (publ), Stockholm (SE)

(72) Inventors: Maxime BOUTON, Santa Clara, CA (US); Hasan FAROOQ, Santa Clara, CA (US); Julien FORGEAT, San Jose, CA (US); Shruti BOTHE, Santa Clara, CA (US); Meral SHIRAZIPOUR, Santa Clara, CA (US)

(73) Assignee: Telefonaktiebolaget LM Ericsson (publ), Stockholm (SE)

(21) Appl. No.: 18/255,362

(22) PCT Filed: Dec. 9, 2020
(86) PCT No.: PCT/IB2020/061668

§ 371 Date: May 31, 2023

(51) Int. Cl. H04W 28/02; H04W 24/02; H04W 28/20

(52) U.S. Cl. CPC H04W 28/0247; H04W 24/02; H04W 28/20

(57) ABSTRACT

A method of a node in a radio access network that optimizes radio access network operations. The method of the node includes determining a topology of the radio access network, exchanging optimization information and network metric information with neighbor nodes in the topology, determining an updated local configuration for the node based on a negotiated optimization with the neighbor nodes, and updating an optimization function based on collected updated network metric information of the node executing the updated local configuration.

### TECHNICAL FIELD

Embodiments of the invention relate to the field of the operations of radio access networks; and more specifically, to a method and system for optimizing radio access networks using reinforcement learning.

### BACKGROUND ART

Mobile cellular telecommunication networks, referred to herein as “mobile networks,” are large networks encompassing a large number of computing devices to enable mobile devices that connect wirelessly to the mobile network to communicate with other computing devices including both other mobile devices and other types of computing devices. The mobile devices, e.g., user equipment (UE) such as mobile phones, tablets, laptops, and similar devices, may frequently travel and shift connection points with the mobile network in a manner that maintains continuous connections for the applications of the mobile devices. Typically, the mobile devices connect to the mobile network via radio access network (RAN) base stations, which provide connectivity to any number of mobile devices for a local area or ‘cell.’ Managing and configuring the mobile network including the cells of the mobile network is an administrative challenge as each cell can have different geographic and technological characteristics.

Machine learning is an area of artificial intelligence (AI) in the field of computer science that applies algorithms and statistical models that are not task specific to perform specific tasks without the use of instructions that are specific to the task to be performed. The algorithms and statistical models can employ pattern recognition, inference, and similar techniques to perform a task rather than specific instructions for the task. Many machine learning algorithms build a model based on training data. Training data can be a set of sample or starting data with known properties such as correlation with a task outcome. The training data are input into the algorithm and model to ‘train’ the AI to perform a task. Machine learning algorithms can be applied to tasks or applications, such as email management or image recognition, where it is difficult or infeasible to develop a conventional algorithm to effectively perform the task.

### SUMMARY

In one embodiment, a method of a node in a radio access network optimizes radio access network operations. The method includes determining a topology of the radio access network, exchanging optimization information and network metric information with neighbor nodes in the topology, determining an updated local configuration for the node based on a negotiated optimization with the neighbor nodes, and updating an optimization function based on collected updated network metric information of the node executing the updated local configuration.

In another embodiment, a network device functions as a part of a node in a radio access network. The network device optimizes radio access network operations. The network device includes a non-transitory machine-readable storage medium having stored therein a optimization coordinator, and a processor coupled to the non-transitory machine-readable storage medium. The processor executes the optimization coordinator. The optimization coordinator determines a topology of the radio access network, exchanges optimization information and network metric information with neighbor nodes in the topology, determines an updated local configuration for the node based on a negotiated optimization with the neighbor nodes, and updates an optimization function based on collected updated network metric information of the node executing the updated local configuration.

In a further embodiment, an electronic device functions as a part of a node in communication with a radio access network. The electronic device implements a plurality of virtual machines that support network function virtualization (NFV), the plurality of virtual machines executes a method to optimize radio access network operations. The electronic device includes a non-transitory machine-readable storage medium having stored therein a optimization coordinator, and a processor coupled to the non-transitory machine-readable storage medium. The processor executes at least one of the plurality of virtual machines. The at least one of the plurality of virtual machines executes the optimization coordinator. The optimization coordinator determines a topology of the radio access network, exchanges optimization information and network metric information with neighbor nodes in the topology, determines an updated local configuration for the node based on a negotiated optimization with the neighbor nodes, and updates an optimization function based on collected updated network metric information of the node executing the updated local configuration.

In one embodiment, an electronic device in a cloud computing environment implements functions to support a node managing configuration of devices in a radio access network. The electronic device optimizes radio access network operations. The electronic device includes a non-transitory machine-readable storage medium having stored therein a optimization coordinator, and a processor coupled to the non-transitory machine-readable storage medium. The processor executes the optimization coordinator. The optimization coordinator determines a topology of the radio access network, exchanges optimization information and network metric information with neighbor nodes in the topology, determines an updated local configuration for the node based on a negotiated optimization with the neighbor nodes, and updates an optimization function based on collected updated network metric information of the node executing the updated local configuration.

### BRIEF DESCRIPTION OF THE DRAWINGS

The invention may best be understood by referring to the following description and accompanying drawings that are used to illustrate embodiments of the invention. In the drawings:

FIG. 1 is a diagram of one embodiment of an example node in a radio access network.

FIG. 2 is a flowchart of one embodiment of a process for optimizing the operation of a radio access network.

FIG. 3 is a flowchart of one example of a process for optimizing the operation of a node in a radio access network.

FIG. 4 is a diagram of one example illustrating the transfer of pretrained optimization functions to another radio access network.

FIG. 5 is a diagram of one example of a distributed implementation of the optimization process for a radio access network.

FIG. 6 is a diagram of one example of a centralized or cloud implementation of the optimization process for a radio access network.

FIG. 7A illustrates connectivity between network devices (NDs) within an exemplary network, as well as three exemplary implementations of the NDs, according to some embodiments of the invention.

FIG. 7B illustrates an exemplary way to implement a special-purpose network device according to some embodiments of the invention.

FIG. 7C illustrates various exemplary ways in which virtual network elements (VNEs) may be coupled according to some embodiments of the invention.

FIG. 7D illustrates a network with a single network element (NE) on each of the NDs, and within this straight forward approach contrasts a traditional distributed approach (commonly used by traditional routers) with a centralized approach for maintaining reachability and forwarding information (also called network control), according to some embodiments of the invention.

FIG. 7E illustrates the simple case of where each of the NDs implements a single NE, but a centralized control plane has abstracted multiple of the NEs in different NDs into (to represent) a single NE in one of the virtual network(s), according to some embodiments of the invention.

FIG. 7F illustrates a case where multiple VNEs are implemented on different NDs and are coupled to each other, and where a centralized control plane has abstracted these multiple VNEs such that they appear as a single VNE within one of the virtual networks, according to some embodiments of the invention.

FIG. 8 illustrates a general purpose control plane device with centralized control plane (CCP) software 850), according to some embodiments of the invention.

### DETAILED DESCRIPTION

The following description describes methods and apparatus for optimizing the operation of nodes in a radio access network. The process trains an optimization function that coordinates and exchanges messages with neighboring nodes in the radio access network. The process uses reinforcement learning to iteratively update the configuration of each node in the radio access network as well as an associated optimization function. In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, solid state drives, read only memory (ROM), flash memory devices, phase change memory) and machine-readable transmission media (also called a carrier) (e.g., electrical, optical, radio, acoustical or other form of propagated signals such as carrier waves, infrared signals). Thus, an electronic device (e.g., a computer) includes hardware and software, such as a set of one or more processors (e.g., wherein a processor is a microprocessor, controller, microcontroller, central processing unit, digital signal processor, application specific integrated circuit, field programmable gate array, other electronic circuitry, a combination of one or more of the preceding) coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set of one or more physical network interface(s) (NI(s)) to establish network connections (to transmit and/or receive code and/or data using propagating signals) with other electronic devices. For example, the set of physical NIs (or the set of physical NI(s) in combination with the set of processors executing code) may perform any formatting, coding, or translating to allow the electronic device to send and receive data whether over a wired and/or a wireless connection. In some embodiments, a physical NI may comprise radio circuitry capable of receiving data from other electronic devices over a wireless connection and/or sending data out to other devices via a wireless connection. This radio circuitry may include transmitter(s), receiver(s), and/or transceiver(s) suitable for radiofrequency communication. The radio circuitry may convert digital data into a radio signal having the appropriate parameters (e.g., frequency, timing, channel, bandwidth, etc.). The radio signal may then be transmitted via antennas to the appropriate recipient(s). In some embodiments, the set of physical NI(s) may comprise network interface controller(s) (NICs), also known as a network interface card, network adapter, or local area network (LAN) adapter. The NIC(s) may facilitate in connecting the electronic device to other electronic devices allowing them to communicate via wire through plugging in a cable to a physical port connected to a NIC. One or more parts of an embodiment of the invention may be implemented using different combinations of software, firmware, and/or hardware.

A network device (ND) is an electronic device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video).

The embodiments provide a process and system for decentralized coordinated reinforcement learning for optimizing radio access networks (RANs). Radio access networks are key infrastructure in mobile telecommunication networks that provide connectivity between user equipment (UE) and the RAN. The RAN is composed of a set of base stations that manage communication with UEs in a region referred to as a cell. The quality of experience (QoE) for a user of a UE in mobile telecommunication networks highly depends on the configuration parameters of the base stations in the RAN. Incorrectly tuned base stations could interfere with neighboring base station operations, e.g., the antennas of neighboring base stations could interfere with one another and deteriorate the signal of users in a sector that would otherwise have good coverage.

To appropriately configure a RAN and the constituent base stations before deployment, engineers have to anticipate many possible traffic conditions as well as possible sources of interference from the environment and the network itself. It is highly likely that the propagation conditions, the traffic distribution, or even the location of the base station would change between the planning and deployment phase due to unforeseen events. As a consequence, it is important that networks have the ability to be optimized and re-configured at deployment time. With a constantly growing demand in high quality services, an increasing network complexity, and highly dynamic environments, relying on human interventions to update network configurations leads to a suboptimal use of the network resources and is often very costly.

To improve on relying on human management, automation of the optimization process can be utilized. For example, the optimization can be used in the context of Self-Organizing Networks (SONs). The SON framework supports capacity and coverage optimization by tuning the parameters of the base stations to improve the network performance. Parameters for self-optimizing networks are hardware parameters such as antenna tilt (electrical and mechanical), azimuth and transmission power, but also software parameters such as Cell Individual Offset (CIO).

Choosing these parameters, usually requires a lot of domain knowledge. To automate the process, a control strategy mapping measurements from the network (e.g., signal strength received by the users) to a base station configuration is determined. This process is automatically applied to determine a new configuration. While the location of the base stations cannot be changed, modifying base stations configurations online to adapt to various traffic conditions can greatly improve the QoE. Within SON, there can be several approaches for automating antenna tuning that can be divided into three categories: hand-engineered rule-based methods, optimization methods, and reinforcement learning based methods. These methods all fall under the broader category of SONs.

Rule-based methods can rely on heuristics which fail to scale with the increasing complexity of telecommunication networks and lead to suboptimal configurations. Optimization methods attempt to formalize certain network configuration problems such as capacity and coverage optimization through antenna tuning and solve it offline. The resulting control strategy is often not flexible to dynamic changes in the traffic distribution. On the other hand, reinforcement learning can offer a principled way to update the tuning strategy online by learning from the stream of data coming to the different base stations. However, reinforcement learning methods may fail to consider coordination between the base stations. In such cases, they consider them as independent agents and do not prevent interferences that might happen in very dense networks that are expected to be deployed. Approaches considering interaction between the base stations, can rely on centralized training which has poor scalability and requires a lot of data transfer between the base stations and a central server.

The embodiments overcome the limitations and disadvantages of the art by providing a process and system using a distributed and coordinated reinforcement learning algorithm for dynamic optimization of RAN configuration (e.g., antenna tuning) taking into account local interactions between the base stations. The examples provided herein relate to antenna tuning, however, these examples are provided by way illustration and not limitation. One skilled in the art would understand that the principles, features and structures described with relation to the examples of antenna tuning are also applicable to optimizing other aspects of network configuration for RANs. In the examples provided herein, each base station includes multiple antennas which are nodes in a network. The embodiments leverage communication between the nodes of the network, through a coordination graph or similar structure, to find a globally optimal joint antenna configuration (as opposed to optimizing each antenna individually) while learning locally.

The embodiments address deficiencies and limitations in previous solutions. Reinforcement learning methods can be used to address the problem of dynamically tuning antennas in cellular networks. However, existing approaches using reinforcement learning either rely on fully independent agents at each base station, hence failing to capture phenomena like interference, or fully centralized architectures, which do not scale to a large number of agents.

Independent Q-learning can also be utilized to optimize network performance in heterogenous networks. Independent Q-learning can be a competitive alternative to genetic algorithms to perform the sort of black box optimization required when optimizing network performance. Independent Q-learning can also be used to find the best beam forming configuration of an antenna. Although these applications of independent Q-learning provide some positive results, the underlying assumption that base stations are independent is not realistic in real deployments and can lead to suboptimal configuration and control strategies.

It is also possible to utilize a centralized approach to coordinate multiple antennas. Although this approach is able to perform global optimization, it is unable to scale to a large number of agents. Similarly, a machine learning architecture in RANs can be constructed that relies on sending data to a central server. However, the embodiments improve on these alternative processes by providing a distributed alternative to these architectures and processes while maintaining the possibility to perform global optimization through a distributed coordination algorithm. The embodiments also provide a theoretically grounded framework using a value function associated with each pair of base stations to optimize the network performance.

The embodiments also improve on a mean field algorithm utilization that considers interactions between agents through the resulting actions of all the neighbors. Measuring this resulting action is difficult in wireless networks. The embodiments provide an end-to-end solution and do not require any extra layer of complexity.

The embodiments utilize the concept of coordinated reinforcement learning to the problem of optimizing base stations parameters in a mobile communication network. The embodiments are described in relation to base station optimization and in some cases specifically to antenna optimization by way of illustration. Those skilled in the art appreciate that the embodiments can be applied to this context as well as possible domain specific extensions. The embodiments are more scalable and lead to more optimal control strategies than previous attempts to optimize base station parameters.

The embodiments represent the mobile communication network using a coordination graph or similar network topology representation. The embodiments include an efficient distributed process to find a globally optimal base station configurations (e.g., joint antenna configuration). In order to dynamically adapt to the environment, the embodiments intertwine the optimization procedure with local reinforcement learning updates in a way that takes advantage of the mobile communication network topology. The embodiments can be implemented in a fully decentralized way, using a cloud server, or any combination thereof. The graph or similar representation of the mobile communication network provides a principled way to encode prior knowledge, transfer knowledge between networks and scale reinforcement learning algorithms in environments requiring strong coordination between the base stations.

The embodiments provide advantages over the art. The embodiments outperform existing technologies in various following aspects. The embodiments provide scalability in the number of base stations optimized or considered in the optimization process. The embodiments do not rely on a centralized entity to coordinate the base stations, and can scale to very large networks making the embodiments well suited to handle the expected densification of mobile communication networks brought by 5G technologies and future technologies. The algorithm is also agnostic to the network topology.

The embodiments enable efficient use of inter-agent communication. The data measured from the network stay local to the base stations and are not sent to a centralized server, thereby avoiding privacy concerns. The coordination mechanism of the embodiments uses a low amount of data transfer. In addition, the distributed nature of the embodiments makes them more resilient to failures in the network.

The embodiments also enable efficient training (computation and sample efficiency) and knowledge transfer. Using a graph or representation of the mobile communication network, the global policy is factorized into small value functions modeling the interaction between each pair of connected base station features (e.g., base station antennas). Those local value functions are often smaller and more efficient to learn than in centralized methods. In addition, the coordination graph or similar representation provides an excellent support for encoding prior knowledge and enabling knowledge transfer between simulation and real world base stations, as well as between different networks.

The embodiments address the problem of optimizing network performance by modeling the problem as a multiagent Markov decision process (MDP) where each base station is an agent. The details on the multiagent MDP framework are discussed further herein below. For the purpose of clarity and conciseness, the following example embodiment description discusses the antenna tilt parameter as an example of an optimizable network and base station parameter, however the embodiments are applicable to any network parameters, including groups of network parameters. Network parameters can further include electrical tilt, transmission power, cell individual offset, azimuth, latitudinal and longitudinal location of cells, beamforming weights, and similar network parameters. In some embodiments, network parameters can also encompass network configuration parameters of the core network including configuration of mobility management entities (MMEs) in 4G networks and access and mobility management functions (AMFs) in 5G networks or similar components. The individual action space of each base station corresponds to a set of possible configurations for network parameters at the base station such as tilt values, azimuth values, power, and similar network parameters. For example, any remotely controllable antenna parameter could be used as the action space (i.e., a set of possible parameter values that can be modified by the embodiments). For example, a finite set of electrical down tilt values ranging from 0° to 16° could be defined as the action space.

Each base station can observe various performance indicators from the network such as the Signal to Interference and Noise Ratio (SINR), Reference Signal Received Power (RSRP), and/or Channel Quality Indicator (CQI) of each user equipment (UE) connected to it. This information can be processed and used as a state input to the reinforcement learning process.

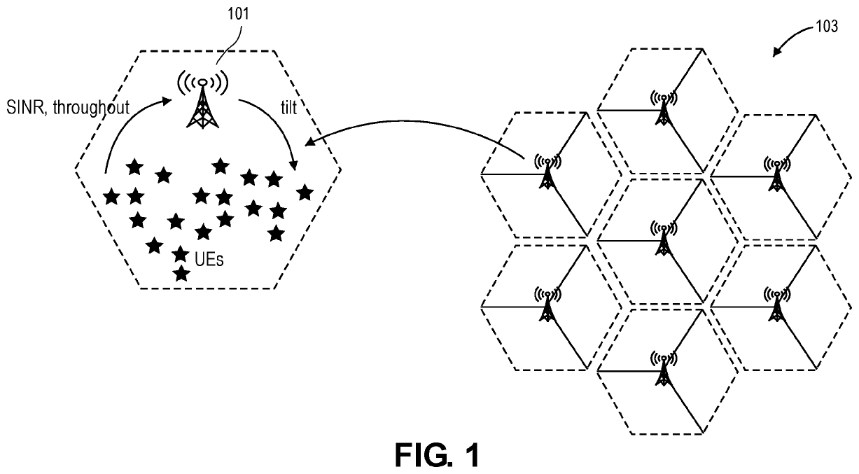

FIG. 1 is a diagram of one embodiment of a set of base stations in a mobile communication network. In the illustration, one base station 101 and the area it serves (i.e., the cell) are illustrated in further detail. In particular, the local interaction loop happening between the base station 101 and its serving sectors is shown.

Each base station 101 (i.e., each agent) is collaborating to improve the quality of the overall network 103. Examples of objectives for optimization are average SINR, number of UEs with SINR above a certain threshold, and similar metrics. This global network wide objective for optimization is distributed into individual rewards at the sector (e.g., cell or group of cells) level such that each agent receives a reward based on its local performance.

The embodiments attempt to find a network wide set of configurations (e.g., a joint antenna configuration) that maximizes the global network performance while primarily considering local measurements at each base station and a limited amount of communication between neighboring base stations to achieve this result. In the illustrated example, the base station 101 collects measurements from the UEs, selects a tilt configuration which in turn affects the UEs. This illustration shows only one base station with three antennas by way of example; however, the coordinated optimization process of the embodiments can consider interaction between any number of base stations 101 and antennas in a mobile communication network 103 of any size.

The operations in the flow diagrams will be described with reference to the exemplary embodiments of the other figures. However, it should be understood that the operations of the flow diagrams can be performed by embodiments of the invention other than those discussed with reference to the other figures, and the embodiments of the invention discussed with reference to these other figures can perform operations different than those discussed with reference to the flow diagrams.

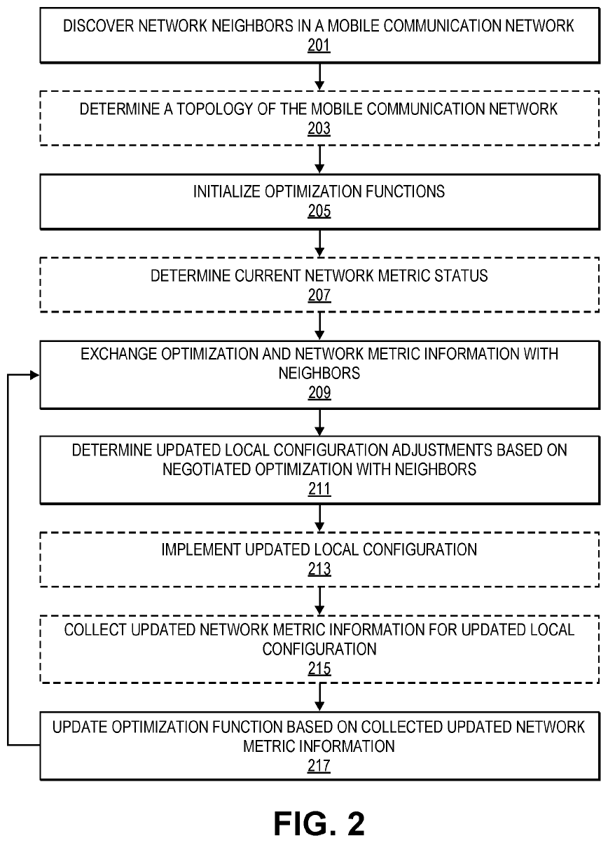

FIG. 2 is a flowchart of one embodiment of a coordinated optimization process as implemented by a node in a mobile communication network. The ‘node,’ as used herein can refer to a base station, a set of components of a base station, computing components that implement functions of the base station, computing resources in a location remote from the base station that manage base station functions, or base station related functions that execute in an edge computing environment, a cloud computing environment, or similar computing environment. A ‘set,’ as used herein, refers to any positive whole number of items, including one item.

The example of the coordinated optimization process of a node as described in relation to FIG. 2 is generalized for any set of network parameter optimizations. The process of the node can be initiated at any point in time, including base station deployment, base station reconfiguration or upgrade, or during normal base station operation. The coordinated optimization process can begin with the node discovering the network neighbors of the base station that the node is associated with (e.g., the base station that is to be configured and optimized by the node) (Block 201). The network neighbors can be any of the other base stations in the mobile communication network (e.g., other base stations in a radio access network (RAN) of the mobile communication network). A ‘neighbor’ can be any base station in geographic proximity to the target base station of the node, any base station with similar characteristics to the target base station, any base station that meets certain communication requirements (e.g., latency), or similar characteristics indicating a similarity in operation between base stations or a proximity in either geographical or communication terms. The ‘neighbor’ nodes can also be identified based on the network parameters to be optimized, such that if any two base stations have a network parameter that may affect the other base station operation, then the two base stations can be considered neighbors as they relate to that network parameter. The node can communicate with other nodes or base stations in the mobile communication network using any messaging mechanism to identify and exchange information with the other nodes or base stations in order to obtain the information needed to identify neighboring base stations or nodes.

Using information determined in the discovery process, the node can construct a representation of the mobile communication network (Block 203). Any representation of the mobile communication network can be utilized including a graph of the mobile communication network. The graph can represent each base station as a node and the edges between nodes can indicate whether each node may affect a network parameter of the other node. The coordinated optimization process can initialize optimization functions for the node (Block 205). An optimization function can be any algorithm or process that determines a reward or similar feedback mechanism responsive to improved optimization by the node for the associated base station and/or the mobile communication network. With these aspects established, then the node can begin to actively optimize the network parameters of the base station based on current network metrics. The optimization functions characterize the performance of each local configuration, which can be considered a local ‘joint’ configuration, in terms of the network metrics being optimized. The local configuration is ‘joint’ because the local configuration is associated with an edge of the graph representation and hence considers multiple (e.g., at least two) antennas at a time and is thus a joint configuration of these antennas and associated components.

The node and/or base station collects relevant network metrics for the network parameters being optimized (Block 207). Any number or variety of metrics can be collected including power consumption, congestion rate, throughput of users, quality of experience (QoE), SINR, RSRP, CQI, and similar metrics. The metrics can be collected over any duration, interval, or time sequence. This can be a continuous process or can be done at scheduled or fixed intervals. The collected network metrics can be exchanged with neighbor nodes along with current optimization or configuration information for the base station (Block 209). Any amount, variety, or combination of network parameter configuration information, optimization information, network metrics, and related information can be provided to the neighbor nodes. Any messaging format, scheme, or protocol can be used to exchange the information with the neighbor nodes. The information shared with neighbor nodes can vary between nodes and can be a synchronous or asynchronous process.

Based on received optimization and network metric data from neighbor nodes, the local configuration and optimization can be updated (Block 211). This local update of optimization and configuration by the node can be responsive to collected data from neighbor nodes or can be iterative to ‘negotiate’ an optimization of configuration and optimization between neighbor nodes. Once the updated configuration and optimizations are determined, the optimization and configuration can be implemented by the node for the base station (Block 213). Once the updated configuration and optimization are implemented, then the base station and node can continue to collect network metrics to determine the efficacy of the updates to the base station configuration and optimization (Block 215). With the updated network metrics collected the optimization function can be evaluated to determine whether the updated configuration and optimization improved the network metrics (Block 217). If the network metrics did not improve, then the optimization function can be updated to disincentivize the updated configuration and optimization relative to better performing configurations or optimizations (Block 217). This process can continue to iterate with further exchanges with neighboring nodes and updates to optimization configuration and functions (Block 209-217) indefinitely. Thus, over time the nodes will find an optimal configuration for each of the base stations for each of the network parameters managed via a coordinated optimization process across each of the nodes of the mobile communication network.

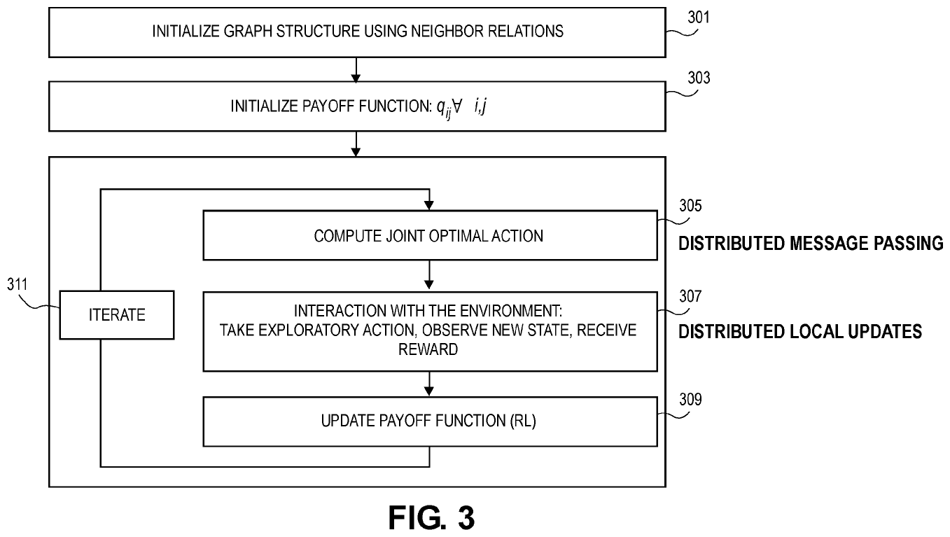

FIG. 3 is a flowchart of one example of a process for optimizing the operation of a node in a radio access network. In this example, the coordinated optimization process is applied to optimize antenna tilt at base stations in the mobile communication network. In this example, the coordinated optimization process utilizes distributed reinforcement as is the case in the general coordinated optimization process.

In this example, the coordinated optimization process assumes knowledge of neighbor relations and begins with the initialization of a graph structure, referred to as a coordination graph, to represent the mobile communication network using the neighbor relation information (Block 301). In this example, the structure of the coordination graph, and then the optimization functions (e.g., a payoff function) at each edge are initialized. A payoff function is a function for incentivizing the node to optimize performance based on coordination with the neighbor nodes. A formal definition of the coordination graph is provided herein below.

The structure of the coordination graph results from neighbor relations. In this example, each antenna is represented as a vertex (base stations can have multiple antennas) or node in the coordination graph. An edge between the vertices of two antennas means that they are likely to influence each other's signal. Neighbor relations can be obtained through automatic procedures as well as using domain knowledge and heuristics to manually define the coordination graph.

A few ways of automatically generating neighbor relations include geographic neighbor relations, radiation patterns, automatic neighbor relations, and using network planning tools. Geographic neighbor relations use the geographic distance between antennas from which it can be determined which antennas are likely to interfere with each other. Antennas belonging to the same base station are connected to each other by edges in the coordination graph and/or physically connected at the base station, and antennas belonging to base stations geographically close are also connected to each other by edges in the coordination graph.

Radiation patterns for determining a coordination graph can use the radiation patterns of the antenna. Using radiation patterns for each antenna it is possible to automatically determine neighbor relations where there is overlap or similar indicating interference between antennas.

Automatic neighbor relations (ANR) can also be used for determining neighbor relations. ANR can be used to determine neighbor relations by using the same standards as defined in the 3^{rd} Generation Partnership Project (3GPP) self-organizing networks (SONS) description that are set forth to define neighbors of each base station for handover decisions.

In addition, it is possible to use network planning tools for determining neighbor relations. Network planning tools that are used to plan the network and rely on path loss and coverage predictions can be leveraged to determine neighboring relations by either a manual or automated process to identify those antennas that are likely to interfere with the operation of other antennas. These methods for neighbor relation determination are principled and automatic ways to define a coordination graph from an existing mobile communication network.

In addition, domain knowledge can be used to refine the coordination graph construction. The domain knowledge can be used by choosing the initial set of base stations that are being optimized. Even if the automatic coordination graph construction method can identify base stations that are not connected, the user must decide initially on the set of base stations in a given area that need to be optimized (e.g., city level, city and suburban areas, country wide coordination graph, or over a similar area). Adding and removing edges from the coordination graph can be based on ad-hoc knowledge. It is possible to use domain expertise to add some edges to the coordination graph if those were not captured by the automated graph construction techniques. Similarly, such domain knowledge can be used to prune edges. Pruning edges and reducing the number of neighbors (degree of the graph) can speed up the optimization procedure described in the next step. This refinement can be via manual or automated processes.

Any combination of the different procedures and the heuristic strategies can be used to define the neighbor connections. In one example, an automatic construction of the coordination graph can use an existing network deployment. A coordination graph can be built using geographical locations of each base station. Each base station includes three antennas which are connected to each other. In addition, the base stations are connected to antennas that are geographical neighbors. Instead of using geographic locations, the graphing process could also use radiation patterns.

Once the coordination graph is constructed in this example of FIG. 3, the payoff and/or optimization function (e.g., referred to herein after as a payoff function) are initialized (Block 303). The payoff functions can be initialized using a random value or using an estimated value. A possibility is to use simulation to determine initial values. In simulation, the process can fix the configuration of all antennas in the network, then choose an edge and sweep through the joint configurations of the connected antennas and set the edge value or payoff function to the performance of the associated sectors. An example initialization algorithm is provided below:

Algorithm 1: Initializing Payoff Functions in Simulation:
1: For each edge (i,j) in the coordination graph
2: Set all antennas to a nominal position (e.g., tilt at 0°)
3: For each configuration aᵢ
4: For each configuration aⱼ
5: Apply configuration aᵢ and aⱼ
6: Run simulation and collect individual rewards rᵢ and rⱼ
7: Set initial payoff function

$${q}_{ij} ( {a}_{i} , {a}_{j} ) = \frac{{r}_{i} + {r}_{j}}{2}$$

The initialization of the payoff function is a way to incorporate expert knowledge in the algorithm. For example, the process can prioritize a base station by using custom weights in line 7:

qᵢⱼ(aᵢ,aⱼ)=wᵢrᵢ+wⱼrⱼ

increasing wᵢ will make the contribution of agent i to the joint payoff more important. The reinforcement learning algorithm will then refine these payoff functions based on the stream of data. Controlling how much the payoff functions should be refined can be done using a multi-fidelity approach.

The process proceeds to computing a joint optimal action and configuration (Block 305). This computation uses message passing (e.g., max-plus) to compute a joint optimal action in a distributed way. At time step t, each agent i observes a local state sᵢ. There are n agents. Computing a globally optimal joint configuration comprises solving the following optimization problem:

$${a}^{*} = {arg max}_{a ∈ ( {A}_{1} , … , {A}_{n} )} {\sum }_{( i , j ) ∈ E} {q}_{ij} ( {s}_{i} , {s}_{j} , {a}_{i} , {a}_{j} )$$

This problem can be solved efficiently, in a distributed and anytime manner using the max-plus algorithm. The max-plus algorithm uses the concept of message-passing that can be described using the following steps: (1) each agent i computes a message, μᵢⱼ(aⱼ), for all its neighbors, corresponding to the maximum payoff that agent i can achieve if its neighbor j takes action aⱼ; (2) the agent sends the messages to its neighbors and receives messages from the neighbor; (3) the algorithm updates the value of its outgoing messages based on the local payoff functions, qᵢⱼ, and the incoming messages μⱼᵢ; and (4) the agents keep sending messages and receiving messages until the value of its outgoing and incoming messages converges.

The computation of these messages is further detailed herein below. Once the optimal joint action procedure has converged, each agent can compute its individual actions by maximizing the sum of incoming messages. This procedure can be implemented in a fully decentralized way. The resulting joint action is proven to converge when the coordination graph is acyclic. If the neighbor assignment methods lead to an acyclic graph, the procedure can know the number of iterations needed to converge. For cyclic graphs, max-plus is not guaranteed to converge to the optimal solution, but empirical evidence shows that it often leads to a near optimal solution. In this case, the joint action procedure can terminate after a determined threshold (e.g., number of iterations of message passing) has been reached.

In this example embodiment, a cycle detection mechanism is utilized. If the value of the messages oscillates between multiple configurations, the mechanism can take the best configuration of the oscillation cycle. This configuration is often optimal (e.g., when compared to exhaustive search) and in cases of suboptimal configuration, the difference with the optimal configuration is minor. The message passing algorithm when applied to a coordination graph involves each agent sending and receiving messages until convergence. After convergence, each incoming message is a summary of the interaction within the whole network and can be used to compute an action that will be globally optimal while only relying on local information.

The actions of Blocks 305-311 implement a reinforcement learning loop in the example of FIG. 3. These steps comprise a reinforcement learning loop with a custom update rule that only uses local information. The first action of the reinforcement loop comprises taking an action and collecting data. Once an optimal joint action is computed through message passing, each agent can decide to take this action or to take an exploratory action according to an exploration strategy such as ϵ-greedy or softmax (Block 307). After the agent takes this action, it receives a reward from the environment. The reward signal can include any type of performance indicator measurable by a base station such as the average SINR, the number of UEs with SINR greater than a threshold, the average throughput, the 10^{th} percentile throughput or SINR for example, or similar performance indicators. In this interaction each agent gathers an experience tuple, (sᵢ,aᵢ,rᵢ,sᵢ′), where sᵢ′ is the state observed after applying configuration aᵢ.

The process then continues to update the payoff functions (Block 309). Updating uses the Q-learning algorithm or similar algorithm to update the local payoff functions at each edge of the coordination graph. For each agent, the individual reward is equally distributed over all its connected edges leading to the following edge update equation:

$${q}_{ij} ( {s}_{i} , {s}_{j} , {a}_{i} , {a}_{j} ) = Update ( α , {q}_{ij} , {s}_{i} , {s}_{j} , {a}_{i} , {a}_{j} , \frac{{r}_{i}}{{N}_{i}} , \frac{{r}_{j}}{{N}_{j}} , {a}_{i}^{*} , {a}_{j}^{*} )$$

where α is the learning rate, sᵢ the observation of antenna i, aᵢ the configuration of antenna i, rᵢ the reward received by antenna i, Nᵢ the number of neighbors of antenna i, aᵢ′ the configuration of antenna i computed by the message passing algorithm. Similar definitions follow for the value indexed by j. The update function can be replaced by any value-based reinforcement learning update. The example embodiments describe the equation in the context of tabular representation, however the algorithm supports any kind of representation for qᵢⱼ for which such update rule is defined. Standard function approximation techniques such as neural network or regression are supported.

This q-learning update scheme gears the payoff function towards estimating the best possible accumulated reward. By combining these local payoff functions through the coordination graph, the joint policy of all the agents converges towards the optimal strategy, maximizing the network performance. The process iterates (Block 311) over computing joint configurations using message passing (Block 305), gathering experience (Block 307), and locally updating the payoff functions (Block 309), thus providing a continuously updating system. These continuous updates allow the network to adapt to changes in the environment in a distributed fashion at the node level.

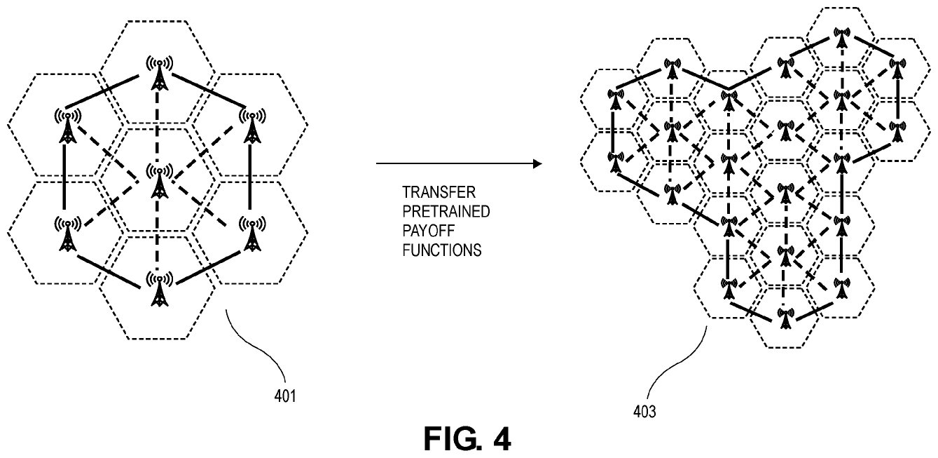

FIG. 4 is a diagram of one example illustrating the transfer of pretrained optimization functions to another radio access network. The embodiments enable the leveraging of the coordination graph to perform transfer learning and accelerate training. The representation of the mobile communication network as a coordination graph enables the transfer of knowledge between multiple networks by copying the optimization function (e.g., a payoff function) at each edge of the coordination graph. Transfer learning can be applied in at least two different use cases, pre-training and accelerated training. Pre-training involves the optimization functions of a given mobile communication network. A transfer process can pre-train the optimization function in a simulation of the target mobile communication network and transfer the weights to the target mobile communication network such that the initially deployed policy will already have a reasonable performance. The pre-training process is a generalization or variation of the warm start procedure discussed herein above.

Accelerating training can involve pre-training in smaller mobile communication networks. The accelerated training process can pretrain a coordination graph in a small mobile communication network to learn local interaction and repeat the local interaction at a larger scale as illustrated in FIG. 4. Some key features of the small scale network can be used to decide where to transfer each edge in the larger scale network e.g., building density, intensity of the traffic, whether a base station is at the geographical extremity of the network or not, and similar features. Edges can be transferred in the area with the most similarity to the area used for training. This transfer procedure can greatly accelerate the re-training in the larger scale network such that the training in the reinforcement loop would resolve faster with less iteration. Key features of the graph such as extremity stations or middle stations can be ported over to larger networks to provide a good initial joint configuration before proceeding to large scale re-training.

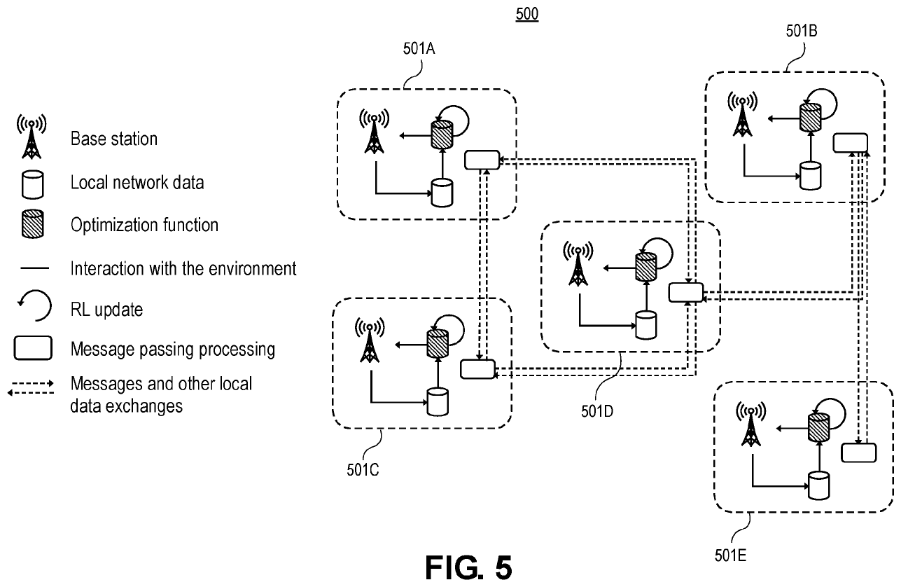

FIG. 5 is a diagram of one example of a distributed implementation of the optimization process for a radio access network. The example mobile communication network 500 includes a set of nodes 501A-E each representing a respective base station. In this example, each base station is treated as having a single antenna per node, however, in other embodiments, multiple antennas can be either grouped as a node or treated as separate nodes. Each node includes at least one respective optimization function (i.e., a reinforcement learning value function) that assesses and incentivizes the operation of the base station for each network parameter to be optimized. Thus, a single base station can be associated with multiple optimization functions. The optimization functions can operate on local network data (i.e., network metrics collected by the base station) to evaluate the configuration of the network parameters for the base station. The nodes also include message passing processes that exchange collected network metric and configuration information with other nodes, specifically neighboring nodes, in the mobile communication network 500. Each node 501A-E can be implemented by any number and combination of electronic devices.

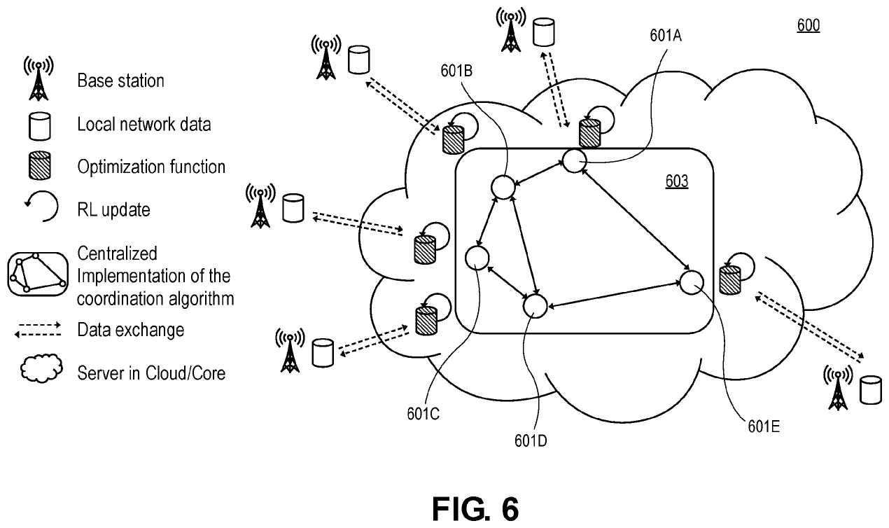

FIG. 6 is a diagram of one example of a centralized or cloud implementation of the optimization process for a radio access network. In this embodiment, the nodes 601A-E are implemented in a cloud computing environment 603. The nodes 601A-E can be implemented in any more centralized computing environment such that each node is in communication with the respective base station that it manages. Similarly, the associated optimization functions can be implemented local to the respective nodes 601A-E, within the cloud computing environment 603, in other locations in the mobile communication network 600 (e.g., via network function virtualization or similar technologies) or at the respective base stations. Local network data can similarly be collected at the base station (as shown), in the mobile communication network 600, in the cloud computing environment 603, or in a similar location accessible to the optimization function and/or the nodes 601A-E.

### Further Detailed Examples

In this section additional details are provided for some embodiments of the data transfer required by the optimization coordination process and what modifications to an existing infrastructure may be needed to deploy the optimization coordination process. A range of implementations are possible from the fully decentralized (i.e., as illustrated in FIG. 5) to the completely cloud based (e.g., as illustrated in FIG. 6). The embodiments improve on existing infrastructure in mobile communication networks, in particular to provide message passing and reinforcement learning.

The message passing of the embodiments can utilize several send and receive operations between base stations. In some embodiments, the messages comprise a table of size |Aᵢ|×|Aⱼ| where each individual action spaces may be within e.g., 20 possible configurations. In existing mobile communication networks, communication protocols between base stations exist, such as the standardized X2 application protocol (X2AP) used for exchanging hand over signaling messages between neighboring base stations. The message passing process can be implemented by augmenting these protocols by sending the information through the control plane. The message passing process can have loose latency requirements and does not overload existing operations. The data exchanged during message passing is an indicator of the performance of the network and does not raise any privacy concerns.

The second part of the optimization coordination process is the reinforcement learning update. For example, the operation updating qᵢⱼ can be executed locally at either agent i or agent j location. After the update, both agents must have the updated copy of qᵢⱼ, which can be achieved in at least two ways: (option 1): perform the update on one side only and transfer qᵢⱼ at the end to the other side. The size of qᵢⱼ depends on the representation used; it could be a table, or neural network weights for example. The overall size should be of the order of MBs; (option 2): if transferring this information is not an efficient use of resources, one could opt for performing the update on both i and j and only transfer the information required to perform the update. To perform the updates, the following information needs to be shared: (1) sᵢ, sⱼ, sᵢ′, and sⱼ′, the observed states at each connected antenna, and rᵢ and rⱼ, the reward signals. sₓ will typically be the list of SINRs and RSRP of the UEs covered by agents i and j. rₓ will be a performance indicator which can often be deduced from the knowledge of sₓ′. This information can already be measured by the base stations. The base stations would have to communicate this information to their neighbors. (2) aᵢ and aⱼ, the configurations of connected antennas, and aᵢ* and aⱼ*, the optimal actions given by the message passing algorithms. aᵢ and aⱼ do not raise privacy concerns and could be shared through the same interface as the messages. aᵢ* and aⱼ* result from running the algorithm and are not accessible in current networks. However, as described above, existing communication protocols (e.g., X2AP) can be relied upon to send those values.

The message passing can be implemented in an anytime fashion and does not require synchronicity between the agents. Similarly, asynchronous updates in reinforcement learning do not harm convergence.

Thus, the embodiments support distributed implementations without the need of a central server. The embodiments utilize the capability of base stations to perform the optimization function updates and to send small size messages to their neighbors. Future base stations can be equipped with compute power largely sufficient to perform those operations. In cases where such capability is not present, one can resort to the centralized alternative, which is more scalable than previous multi-agent architectures. Thus, the embodiments provide a distributed coordinated reinforcement to optimize network configuration online. The representation of the cellular networks as a coordination graph allows global optimization to be performed in a distributed way and using local information and communication. The embodiments provide the possibility to transfer knowledge through the edge of the graph either by smart initialization (simulation or expert knowledge) or transferring knowledge across networks.

Cooperative Multi Agent Reinforcement Learning

In cooperative multi agent reinforcement learning, as used herein, a group of agents is trying to maximize a common objective. Each agent controls its action using a policy which is a mapping from its local observation of the environment to an action. At each time step t, each agent i takes an action and receives an individual reward signal rᵢ^{t}. The goal of the group of agents is to maximize the expected collective amount of reward accumulated over time:

Eₛ_{₀}_{,π}[ΣₜΣᵢrᵢ^{t}]

For each agent i, it is noted πᵢ: Sᵢ→Aᵢ such that its policy maps its local observations to an individual action. Bold letters represent the joint observations, joint actions and joint policies: s=(s₁, . . . , sₙ), a=(a₁, . . . , aₙ), π=(π₁, . . . , πₙ). In reinforcement learning, policies can be represented using value functions. A value function Q(s,a), represents the expected reward obtained by the group of agents while taking action a, in state s. The policy associated with this value function is then given by π(s, a)=argmax_{a∈(A}_{₁}_{, . . . ,A}_{ₙ})Q(s, a).

In multi-agent reinforcement learning, the space of possible state and action grows exponentially with the number of agents making Q very difficult to represent and finding the optimal joint action is also challenging. To address this curse of dimensionality, one can rely on function approximation and represent Q by a neural network for example. Another approach is to make assumptions on the dependencies between agent and factorize the joint value function into local components. One common assumption is to consider that each agent is independent. The global value function is then expressed as follows: Q(s,a)=Σᵢ Qᵢ(sᵢ,aᵢ). Each individual component Qᵢ is small and easy to learn since it considers only one agent. The joint policy is easily obtained by maximizing each individual value function. Although this approach can scale to a large number of agents, the strong assumption of independence can lead to suboptimal policies. Each agent is selfishly optimizing its own value function.

Coordinated Reinforcement Learning

A coordination graph G is defined by a set of vertices V and a set of undirected edges E. Each edge (i,j)∈E is associated with a payoff function qᵢⱼ:Aᵢ×Aⱼ→R, mapping the joint configuration of i and j to a real number. Since the payoff function considers the configuration of each pair of connected antennas, it can capture potential interfering configuration. The global payoff can be expressed as the sum of the local payoff in the graph: Q(s, a)=Σ_{(i,j)∈E}qᵢⱼ(sᵢ,sⱼ,aᵢ,aⱼ). There exists an efficient algorithm to maximize payoff functions in coordination graphs relying on message passing. The message passing algorithm allows propagating local interaction at the global scale and finding a globally optimal solution while only having to model local interactions.

In coordinated reinforcement learning, the dependencies between the agents are modeled using a coordination graph. The global value function is expressed as the sum of the value function of the edges. The value of the edges can be learned locally. As they only consider a pair of agents, the representation of the function is not an issue. Here is an example of update rule for the edges of the graph, in the case of tabular representations:

$${q}_{ij} ( {s}_{i} , {s}_{j} , {a}_{i} , {a}_{j} ) = ( 1 - α ) {q}_{ij} ( {s}_{i} , {s}_{j} , {a}_{i} , {a}_{j} ) + α [ \frac{{r}_{i}}{{N}_{i}} + \frac{{r}_{j}}{{N}_{j}} + γ {q}_{ij} ( {s}_{i}^{′} , {s}_{j}^{′} , {a}_{i}^{*} , {a}_{j}^{*} ) ]$$

Where α is the learning rate, γ is the discount rate, Nᵢ and Nⱼ the number of neighbors of i and j respectively, aₓ* are the actions found by the message passing algorithm, the other values are from the standard Q-learning experience tuple.

Message Passing

Messages can be computed as follows, using the corresponding edge optimization function and the incoming messages:

$${μ}_{ij} ( {a}_{j} ) = {max}_{{a}_{i}} \{ {q}_{ij} ( {a}_{i} , {a}_{j} ) + {\sum }_{k ∈ N ( i ) \backslash j} {μ}_{ki} ( {a}_{i} ) \} + {c}_{ij}$$

cᵢⱼ is a normalizing term for keeping the size of the messages small in cyclic graph. Typically

$${c}_{ij} = \frac{1}{\vert A \vert} {\sum }_{k} {μ}_{ik} ( {a}_{k} ) .$$

After convergence, each agent can select its individually optimal action:

$${a}_{i}^{*} = arg {max}_{{a}_{i}} \{ {f}_{i} ( {a}_{i} ) + {\sum }_{j ∈ N ( i )} {μ}_{ji} ( {a}_{i} ) \}$$

where fᵢ denotes the local payoff function for agent i and is only based on its individual action aᵢ.

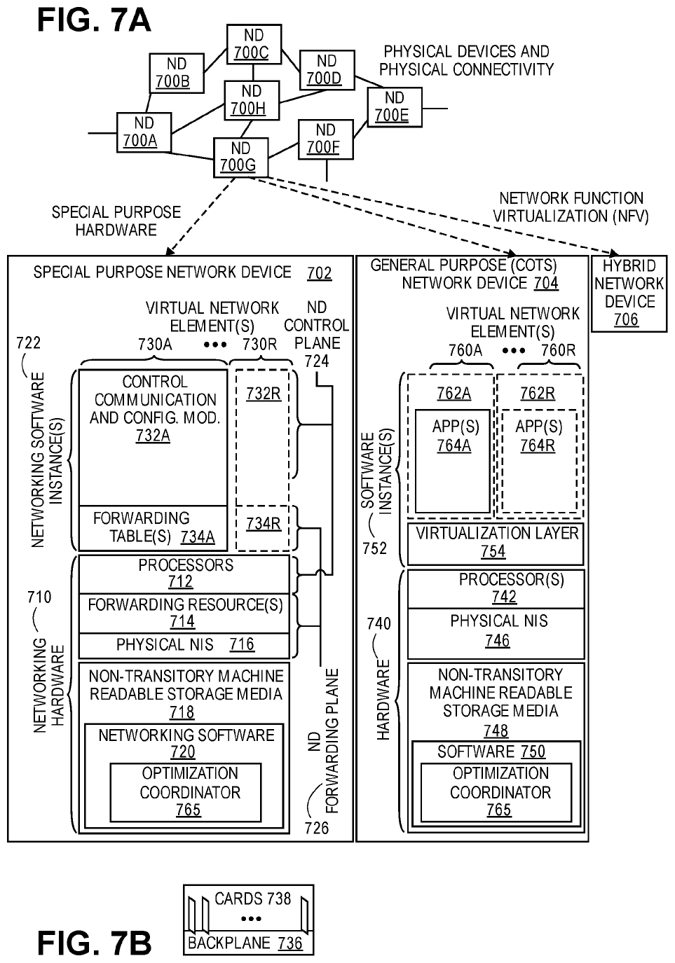

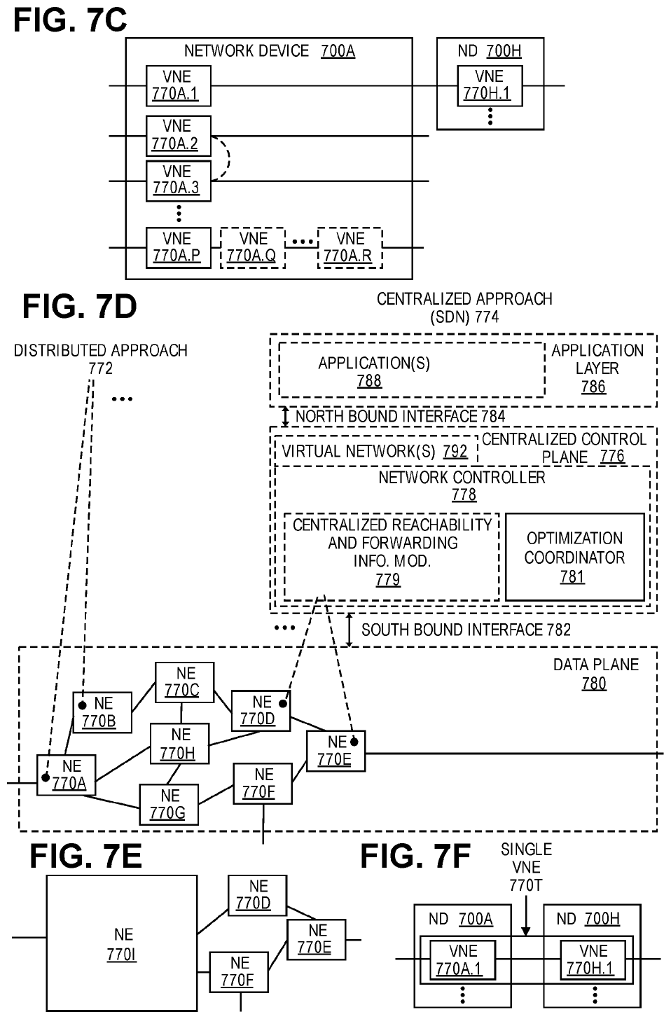

FIG. 7A illustrates connectivity between network devices (NDs) within an exemplary network, as well as three exemplary implementations of the NDs, according to some embodiments of the invention. FIG. 7A shows NDs 700A-H, and their connectivity by way of lines between 700A-700B, 700B-700C, 700C-700D, 700D-700E, 700E-700F, 700F-700G, and 700A-700G, as well as between 700H and each of 700A, 700C, 700D, and 700G. These NDs are physical devices, and the connectivity between these NDs can be wireless or wired (often referred to as a link). An additional line extending from NDs 700A, 700E, and 700F illustrates that these NDs act as ingress and egress points for the network (and thus, these NDs are sometimes referred to as edge NDs; while the other NDs may be called core NDs).

Two of the exemplary ND implementations in FIG. 7A are: 1) a special-purpose network device 702 that uses custom application-specific integrated-circuits (ASICs) and a special-purpose operating system (OS); and 2) a general purpose network device 704 that uses common off-the-shelf (COTS) processors and a standard OS.

The special-purpose network device 702 includes networking hardware 710 comprising a set of one or more processor(s) 712, forwarding resource(s) 714 (which typically include one or more ASICs and/or network processors), and physical network interfaces (NIs) 716 (through which network connections are made, such as those shown by the connectivity between NDs 700A-H), as well as non-transitory machine readable storage media 718 having stored therein networking software 720. During operation, the networking software 720 may be executed by the networking hardware 710 to instantiate a set of one or more networking software instance(s) 722. Each of the networking software instance(s) 722, and that part of the networking hardware 710 that executes that network software instance (be it hardware dedicated to that networking software instance and/or time slices of hardware temporally shared by that networking software instance with others of the networking software instance(s) 722), form a separate virtual network element 730A-R. Each of the virtual network element(s) (VNEs) 730A-R includes a control communication and configuration module 732A-R (sometimes referred to as a local control module or control communication module) and forwarding table(s) 734A-R, such that a given virtual network element (e.g., 730A) includes the control communication and configuration module (e.g., 732A), a set of one or more forwarding table(s) (e.g., 734A), and that portion of the networking hardware 710 that executes the virtual network element (e.g., 730A). Networking software 720 can include an optimization coordinator 765 that implements the optimization coordination process described herein. The optimization coordinator 765 can be executed by the processing resources 714 and stored in the non-transitory machine readable media 718.

The special-purpose network device 702 is often physically and/or logically considered to include: 1) a ND control plane 724 (sometimes referred to as a control plane) comprising the processor(s) 712 that execute the control communication and configuration module(s) 732A-R; and 2) a ND forwarding plane 726 (sometimes referred to as a forwarding plane, a data plane, or a media plane) comprising the forwarding resource(s) 714 that utilize the forwarding table(s) 734A-R and the physical NIs 716. By way of example, where the ND is a router (or is implementing routing functionality), the ND control plane 724 (the processor(s) 712 executing the control communication and configuration module(s) 732A-R) is typically responsible for participating in controlling how data (e.g., packets) is to be routed (e.g., the next hop for the data and the outgoing physical NI for that data) and storing that routing information in the forwarding table(s) 734A-R, and the ND forwarding plane 726 is responsible for receiving that data on the physical NIs 716 and forwarding that data out the appropriate ones of the physical NIs 716 based on the forwarding table(s) 734A-R.

FIG. 7B illustrates an exemplary way to implement the special-purpose network device 702 according to some embodiments of the invention. FIG. 7B shows a special-purpose network device including cards 738 (typically hot pluggable). While in some embodiments the cards 738 are of two types (one or more that operate as the ND forwarding plane 726 (sometimes called line cards), and one or more that operate to implement the ND control plane 724 (sometimes called control cards)), alternative embodiments may combine functionality onto a single card and/or include additional card types (e.g., one additional type of card is called a service card, resource card, or multi-application card). A service card can provide specialized processing (e.g., Layer 4 to Layer 7 services (e.g., firewall, Internet Protocol Security (IPsec), Secure Sockets Layer (SSL)/Transport Layer Security (TLS), Intrusion Detection System (IDS), peer-to-peer (P2P), Voice over IP (VoIP) Session Border Controller, Mobile Wireless Gateways (Gateway General Packet Radio Service (GPRS) Support Node (GGSN), Evolved Packet Core (EPC) Gateway)). By way of example, a service card may be used to terminate IPsec tunnels and execute the attendant authentication and encryption algorithms. These cards are coupled together through one or more interconnect mechanisms illustrated as backplane 736 (e.g., a first full mesh coupling the line cards and a second full mesh coupling all of the cards).

Returning to FIG. 7A, the general purpose network device 704 includes hardware 740 comprising a set of one or more processor(s) 742 (which are often COTS processors) and physical NIs 746, as well as non-transitory machine readable storage media 748 having stored therein software 750. During operation, the processor(s) 742 execute the software 750 to instantiate one or more sets of one or more applications 764A-R. While one embodiment does not implement virtualization, alternative embodiments may use different forms of virtualization. For example, in one such alternative embodiment the virtualization layer 754 represents the kernel of an operating system (or a shim executing on a base operating system) that allows for the creation of multiple instances 762A-R called software containers that may each be used to execute one (or more) of the sets of applications 764A-R; where the multiple software containers (also called virtualization engines, virtual private servers, or jails) are user spaces (typically a virtual memory space) that are separate from each other and separate from the kernel space in which the operating system is run; and where the set of applications running in a given user space, unless explicitly allowed, cannot access the memory of the other processes. In another such alternative embodiment the virtualization layer 754 represents a hypervisor (sometimes referred to as a virtual machine monitor (VIVANT)) or a hypervisor executing on top of a host operating system, and each of the sets of applications 764A-R is run on top of a guest operating system within an instance 762A-R called a virtual machine (which may in some cases be considered a tightly isolated form of software container) that is run on top of the hypervisor—the guest operating system and application may not know they are running on a virtual machine as opposed to running on a “bare metal” host electronic device, or through para-virtualization the operating system and/or application may be aware of the presence of virtualization for optimization purposes. In yet other alternative embodiments, one, some or all of the applications are implemented as unikernel(s), which can be generated by compiling directly with an application only a limited set of libraries (e.g., from a library operating system (LibOS) including drivers/libraries of OS services) that provide the particular OS services needed by the application. As a unikernel can be implemented to run directly on hardware 740, directly on a hypervisor (in which case the unikernel is sometimes described as running within a LibOS virtual machine), or in a software container, embodiments can be implemented fully with unikernels running directly on a hypervisor represented by virtualization layer 754, unikernels running within software containers represented by instances 762A-R, or as a combination of unikernels and the above-described techniques (e.g., unikernels and virtual machines both run directly on a hypervisor, unikernels and sets of applications that are run in different software containers). Software 750 can include an optimization coordinator 765 that implements the optimization coordination process described herein. The optimization coordinator 765 can be executed by the processing resources 742 and stored in the non-transitory machine readable media 748.

The instantiation of the one or more sets of one or more applications 764A-R, as well as virtualization if implemented, are collectively referred to as software instance(s) 752. Each set of applications 764A-R, corresponding virtualization construct (e.g., instance 762A-R) if implemented, and that part of the hardware 740 that executes them (be it hardware dedicated to that execution and/or time slices of hardware temporally shared), forms a separate virtual network element(s) 760A-R.

The virtual network element(s) 760A-R perform similar functionality to the virtual network element(s) 730A-R—e.g., similar to the control communication and configuration module(s) 732A and forwarding table(s) 734A (this virtualization of the hardware 740 is sometimes referred to as network function virtualization (NFV)). Thus, NFV may be used to consolidate many network equipment types onto industry standard high volume server hardware, physical switches, and physical storage, which could be located in Data centers, NDs, and customer premise equipment (CPE). While embodiments of the invention are illustrated with each instance 762A-R corresponding to one VNE 760A-R, alternative embodiments may implement this correspondence at a finer level granularity (e.g., line card virtual machines virtualize line cards, control card virtual machine virtualize control cards, etc.); it should be understood that the techniques described herein with reference to a correspondence of instances 762A-R to VNEs also apply to embodiments where such a finer level of granularity and/or unikernels are used.

In certain embodiments, the virtualization layer 754 includes a virtual switch that provides similar forwarding services as a physical Ethernet switch. Specifically, this virtual switch forwards traffic between instances 762A-R and the physical NI(s) 746, as well as optionally between the instances 762A-R; in addition, this virtual switch may enforce network isolation between the VNEs 760A-R that by policy are not permitted to communicate with each other (e.g., by honoring virtual local area networks (VLANs)).

The third exemplary ND implementation in FIG. 7A is a hybrid network device 706, which includes both custom ASICs/special-purpose OS and COTS processors/standard OS in a single ND or a single card within an ND. In certain embodiments of such a hybrid network device, a platform VM (i.e., a VM that that implements the functionality of the special-purpose network device 702) could provide for para-virtualization to the networking hardware present in the hybrid network device 706.

Regardless of the above exemplary implementations of an ND, when a single one of multiple VNEs implemented by an ND is being considered (e.g., only one of the VNEs is part of a given virtual network) or where only a single VNE is currently being implemented by an ND, the shortened term network element (NE) is sometimes used to refer to that VNE. Also in all of the above exemplary implementations, each of the VNEs (e.g., VNE(s) 730A-R, VNEs 760A-R, and those in the hybrid network device 706) receives data on the physical NIs (e.g., 716, 746) and forwards that data out the appropriate ones of the physical NIs (e.g., 716, 746). For example, a VNE implementing IP router functionality forwards IP packets on the basis of some of the IP header information in the IP packet; where IP header information includes source IP address, destination IP address, source port, destination port (where “source port” and “destination port” refer herein to protocol ports, as opposed to physical ports of a ND), transport protocol (e.g., user datagram protocol (UDP), Transmission Control Protocol (TCP), and differentiated services code point (DSCP) values.

FIG. 7C illustrates various exemplary ways in which VNEs may be coupled according to some embodiments of the invention. FIG. 7C shows VNEs 770A.1-770A.P (and optionally VNEs 770A.Q-770A.R) implemented in ND 700A and VNE 770H.1 in ND 700H. In FIG. 7C, VNEs 770A.1-P are separate from each other in the sense that they can receive packets from outside ND 700A and forward packets outside of ND 700A; VNE 770A.1 is coupled with VNE 770H.1, and thus they communicate packets between their respective NDs; VNE 770A.2-770A.3 may optionally forward packets between themselves without forwarding them outside of the ND 700A; and VNE 770A.P may optionally be the first in a chain of VNEs that includes VNE 770A.Q followed by VNE 770A.R (this is sometimes referred to as dynamic service chaining, where each of the VNEs in the series of VNEs provides a different service—e.g., one or more layer 4-7 network services). While FIG. 7C illustrates various exemplary relationships between the VNEs, alternative embodiments may support other relationships (e.g., more/fewer VNEs, more/fewer dynamic service chains, multiple different dynamic service chains with some common VNEs and some different VNEs).

The NDs of FIG. 7A, for example, may form part of the Internet or a private network; and other electronic devices (not shown; such as end user devices including workstations, laptops, netbooks, tablets, palm tops, mobile phones, smartphones, phablets, multimedia phones, Voice Over Internet Protocol (VOIP) phones, terminals, portable media players, GPS units, wearable devices, gaming systems, set-top boxes, Internet enabled household appliances) may be coupled to the network (directly or through other networks such as access networks) to communicate over the network (e.g., the Internet or virtual private networks (VPNs) overlaid on (e.g., tunneled through) the Internet) with each other (directly or through servers) and/or access content and/or services. Such content and/or services are typically provided by one or more servers (not shown) belonging to a service/content provider or one or more end user devices (not shown) participating in a peer-to-peer (P2P) service, and may include, for example, public webpages (e.g., free content, store fronts, search services), private webpages (e.g., username/password accessed webpages providing email services), and/or corporate networks over VPNs. For instance, end user devices may be coupled (e.g., through customer premise equipment coupled to an access network (wired or wirelessly)) to edge NDs, which are coupled (e.g., through one or more core NDs) to other edge NDs, which are coupled to electronic devices acting as servers. However, through compute and storage virtualization, one or more of the electronic devices operating as the NDs in FIG. 7A may also host one or more such servers (e.g., in the case of the general purpose network device 704, one or more of the software instances 762A-R may operate as servers; the same would be true for the hybrid network device 706; in the case of the special-purpose network device 702, one or more such servers could also be run on a virtualization layer executed by the processor(s) 712); in which case the servers are said to be co-located with the VNEs of that ND.

A virtual network is a logical abstraction of a physical network (such as that in FIG. 7A) that provides network services (e.g., L2 and/or L3 services). A virtual network can be implemented as an overlay network (sometimes referred to as a network virtualization overlay) that provides network services (e.g., layer 2 (L2, data link layer) and/or layer 3 (L3, network layer) services) over an underlay network (e.g., an L3 network, such as an Internet Protocol (IP) network that uses tunnels (e.g., generic routing encapsulation (GRE), layer 2 tunneling protocol (L2TP), IPSec) to create the overlay network).

A network virtualization edge (NVE) sits at the edge of the underlay network and participates in implementing the network virtualization; the network-facing side of the NVE uses the underlay network to tunnel frames to and from other NVEs; the outward-facing side of the NVE sends and receives data to and from systems outside the network. A virtual network instance (VNI) is a specific instance of a virtual network on a NVE (e.g., a NE/VNE on an ND, a part of a NE/VNE on a ND where that NE/VNE is divided into multiple VNEs through emulation); one or more VNIs can be instantiated on an NVE (e.g., as different VNEs on an ND). A virtual access point (VAP) is a logical connection point on the NVE for connecting external systems to a virtual network; a VAP can be physical or virtual ports identified through logical interface identifiers (e.g., a VLAN ID).

Examples of network services include: 1) an Ethernet LAN emulation service (an Ethernet-based multipoint service similar to an Internet Engineering Task Force (IETF) Multiprotocol Label Switching (MPLS) or Ethernet VPN (EVPN) service) in which external systems are interconnected across the network by a LAN environment over the underlay network (e.g., an NVE provides separate L2 VNIs (virtual switching instances) for different such virtual networks, and L3 (e.g., IP/MPLS) tunneling encapsulation across the underlay network); and 2) a virtualized IP forwarding service (similar to IETF IP VPN (e.g., Border Gateway Protocol (BGP)/MPLS IPVPN) from a service definition perspective) in which external systems are interconnected across the network by an L3 environment over the underlay network (e.g., an NVE provides separate L3 VNIs (forwarding and routing instances) for different such virtual networks, and L3 (e.g., IP/MPLS) tunneling encapsulation across the underlay network)). Network services may also include quality of service capabilities (e.g., traffic classification marking, traffic conditioning and scheduling), security capabilities (e.g., filters to protect customer premises from network—originated attacks, to avoid malformed route announcements), and management capabilities (e.g., full detection and processing).

FIG. 7D illustrates a network with a single network element on each of the NDs of FIG. 7A, and within this straight forward approach contrasts a traditional distributed approach (commonly used by traditional routers) with a centralized approach for maintaining reachability and forwarding information (also called network control), according to some embodiments of the invention. Specifically, FIG. 7D illustrates network elements (NEs) 770A-H with the same connectivity as the NDs 700A-H of FIG. 7A.

FIG. 7D illustrates that the distributed approach 772 distributes responsibility for generating the reachability and forwarding information across the NEs 770A-H; in other words, the process of neighbor discovery and topology discovery is distributed.

For example, where the special-purpose network device 702 is used, the control communication and configuration module(s) 732A-R of the ND control plane 724 typically include a reachability and forwarding information module to implement one or more routing protocols (e.g., an exterior gateway protocol such as Border Gateway Protocol (BGP), Interior Gateway Protocol(s) (IGP) (e.g., Open Shortest Path First (OSPF), Intermediate System to Intermediate System (IS-IS), Routing Information Protocol (RIP), Label Distribution Protocol (LDP), Resource Reservation Protocol (RSVP) (including RSVP-Traffic Engineering (TE): Extensions to RSVP for LSP Tunnels and Generalized Multi-Protocol Label Switching (GMPLS) Signaling RSVP-TE)) that communicate with other NEs to exchange routes, and then selects those routes based on one or more routing metrics. Thus, the NEs 770A-H (e.g., the processor(s) 712 executing the control communication and configuration module(s) 732A-R) perform their responsibility for participating in controlling how data (e.g., packets) is to be routed (e.g., the next hop for the data and the outgoing physical NI for that data) by distributively determining the reachability within the network and calculating their respective forwarding information. Routes and adjacencies are stored in one or more routing structures (e.g., Routing Information Base (RIB), Label Information Base (LIB), one or more adjacency structures) on the ND control plane 724. The ND control plane 724 programs the ND forwarding plane 726 with information (e.g., adjacency and route information) based on the routing structure(s). For example, the ND control plane 724 programs the adjacency and route information into one or more forwarding table(s) 734A-R (e.g., Forwarding Information Base (FIB), Label Forwarding Information Base (LFIB), and one or more adjacency structures) on the ND forwarding plane 726. For layer 2 forwarding, the ND can store one or more bridging tables that are used to forward data based on the layer 2 information in that data. While the above example uses the special-purpose network device 702, the same distributed approach 772 can be implemented on the general purpose network device 704 and the hybrid network device 706.

FIG. 7D illustrates that a centralized approach 774 (also known as software defined networking (SDN)) that decouples the system that makes decisions about where traffic is sent from the underlying systems that forwards traffic to the selected destination. The illustrated centralized approach 774 has the responsibility for the generation of reachability and forwarding information in a centralized control plane 776 (sometimes referred to as a SDN control module, controller, network controller, OpenFlow controller, SDN controller, control plane node, network virtualization authority, or management control entity), and thus the process of neighbor discovery and topology discovery is centralized. The centralized control plane 776 has a south bound interface 782 with a data plane 780 (sometime referred to the infrastructure layer, network forwarding plane, or forwarding plane (which should not be confused with a ND forwarding plane)) that includes the NEs 770A-H (sometimes referred to as switches, forwarding elements, data plane elements, or nodes). The centralized control plane 776 includes a network controller 778, which includes a centralized reachability and forwarding information module 779 that determines the reachability within the network and distributes the forwarding information to the NEs 770A-H of the data plane 780 over the south bound interface 782 (which may use the OpenFlow protocol). Thus, the network intelligence is centralized in the centralized control plane 776 executing on electronic devices that are typically separate from the NDs. Networking controller 778 or similar aspect of the centralized approach 774 can include an optimization coordinator 781 that implements the optimization coordination process described herein.

For example, where the special-purpose network device 702 is used in the data plane 780, each of the control communication and configuration module(s) 732A-R of the ND control plane 724 typically include a control agent that provides the VNE side of the south bound interface 782. In this case, the ND control plane 724 (the processor(s) 712 executing the control communication and configuration module(s) 732A-R) performs its responsibility for participating in controlling how data (e.g., packets) is to be routed (e.g., the next hop for the data and the outgoing physical NI for that data) through the control agent communicating with the centralized control plane 776 to receive the forwarding information (and in some cases, the reachability information) from the centralized reachability and forwarding information module 779 (it should be understood that in some embodiments of the invention, the control communication and configuration module(s) 732A-R, in addition to communicating with the centralized control plane 776, may also play some role in determining reachability and/or calculating forwarding information—albeit less so than in the case of a distributed approach; such embodiments are generally considered to fall under the centralized approach 774, but may also be considered a hybrid approach).

While the above example uses the special-purpose network device 702, the same centralized approach 774 can be implemented with the general purpose network device 704 (e.g., each of the VNE 760A-R performs its responsibility for controlling how data (e.g., packets) is to be routed (e.g., the next hop for the data and the outgoing physical NI for that data) by communicating with the centralized control plane 776 to receive the forwarding information (and in some cases, the reachability information) from the centralized reachability and forwarding information module 779; it should be understood that in some embodiments of the invention, the VNEs 760A-R, in addition to communicating with the centralized control plane 776, may also play some role in determining reachability and/or calculating forwarding information—albeit less so than in the case of a distributed approach) and the hybrid network device 706. In fact, the use of SDN techniques can enhance the NFV techniques typically used in the general purpose network device 704 or hybrid network device 706 implementations as NFV is able to support SDN by providing an infrastructure upon which the SDN software can be run, and NFV and SDN both aim to make use of commodity server hardware and physical switches.

FIG. 7D also shows that the centralized control plane 776 has a north bound interface 784 to an application layer 786, in which resides application(s) 788. The centralized control plane 776 has the ability to form virtual networks 792 (sometimes referred to as a logical forwarding plane, network services, or overlay networks (with the NEs 770A-H of the data plane 780 being the underlay network)) for the application(s) 788. Thus, the centralized control plane 776 maintains a global view of all NDs and configured NEs/VNEs, and it maps the virtual networks to the underlying NDs efficiently (including maintaining these mappings as the physical network changes either through hardware (ND, link, or ND component) failure, addition, or removal).

While FIG. 7D shows the distributed approach 772 separate from the centralized approach 774, the effort of network control may be distributed differently or the two combined in certain embodiments of the invention. For example: 1) embodiments may generally use the centralized approach (SDN) 774, but have certain functions delegated to the NEs (e.g., the distributed approach may be used to implement one or more of fault monitoring, performance monitoring, protection switching, and primitives for neighbor and/or topology discovery); or 2) embodiments of the invention may perform neighbor discovery and topology discovery via both the centralized control plane and the distributed protocols, and the results compared to raise exceptions where they do not agree. Such embodiments are generally considered to fall under the centralized approach 774, but may also be considered a hybrid approach.

While FIG. 7D illustrates the simple case where each of the NDs 700A-H implements a single NE 770A-H, it should be understood that the network control approaches described with reference to FIG. 7D also work for networks where one or more of the NDs 700A-H implement multiple VNEs (e.g., VNEs 730A-R, VNEs 760A-R, those in the hybrid network device 706). Alternatively, or in addition, the network controller 778 may also emulate the implementation of multiple VNEs in a single ND. Specifically, instead of (or in addition to) implementing multiple VNEs in a single ND, the network controller 778 may present the implementation of a VNE/NE in a single ND as multiple VNEs in the virtual networks 792 (all in the same one of the virtual network(s) 792, each in different ones of the virtual network(s) 792, or some combination). For example, the network controller 778 may cause an ND to implement a single VNE (a NE) in the underlay network, and then logically divide up the resources of that NE within the centralized control plane 776 to present different VNEs in the virtual network(s) 792 (where these different VNEs in the overlay networks are sharing the resources of the single VNE/NE implementation on the ND in the underlay network).

On the other hand, FIGS. 7E and 7F respectively illustrate exemplary abstractions of NEs and VNEs that the network controller 778 may present as part of different ones of the virtual networks 792. FIG. 7E illustrates the simple case of where each of the NDs 700A-H implements a single NE 770A-H (see FIG. 7D), but the centralized control plane 776 has abstracted multiple of the NEs in different NDs (the NEs 770A-C and G-H) into (to represent) a single NE 7701 in one of the virtual network(s) 792 of FIG. 7D, according to some embodiments of the invention. FIG. 7E shows that in this virtual network, the NE 7701 is coupled to NE 770D and 770F, which are both still coupled to NE 770E.

FIG. 7F illustrates a case where multiple VNEs (VNE 770A.1 and VNE 770H.1) are implemented on different NDs (ND 700A and ND 700H) and are coupled to each other, and where the centralized control plane 776 has abstracted these multiple VNEs such that they appear as a single VNE 770T within one of the virtual networks 792 of FIG. 7D, according to some embodiments of the invention. Thus, the abstraction of a NE or VNE can span multiple NDs.

While some embodiments of the invention implement the centralized control plane 776 as a single entity (e.g., a single instance of software running on a single electronic device), alternative embodiments may spread the functionality across multiple entities for redundancy and/or scalability purposes (e.g., multiple instances of software running on different electronic devices).

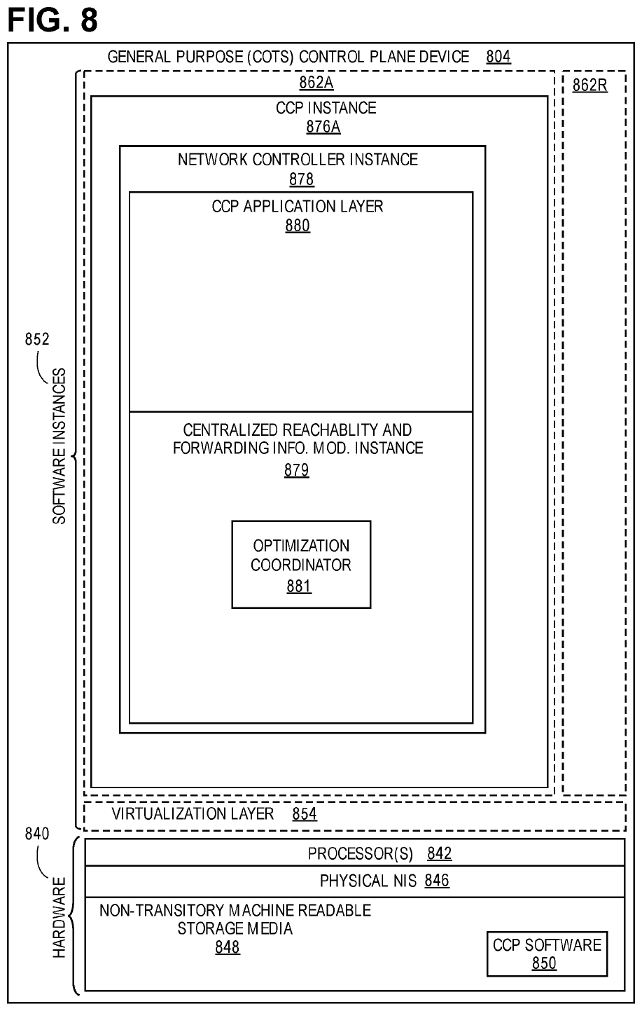

Similar to the network device implementations, the electronic device(s) running the centralized control plane 776, and thus the network controller 778 including the centralized reachability and forwarding information module 779, may be implemented a variety of ways (e.g., a special purpose device, a general-purpose (e.g., COTS) device, or hybrid device). These electronic device(s) would similarly include processor(s), a set of one or more physical NIs, and a non-transitory machine-readable storage medium having stored thereon the centralized control plane software. For instance, FIG. 8 illustrates, a general purpose control plane device 804 including hardware 840 comprising a set of one or more processor(s) 842 (which are often COTS processors) and physical NIs 846, as well as non-transitory machine readable storage media 848 having stored therein centralized control plane (CCP) software 850.

In embodiments that use compute virtualization, the processor(s) 842 typically execute software to instantiate a virtualization layer 854 (e.g., in one embodiment the virtualization layer 854 represents the kernel of an operating system (or a shim executing on a base operating system) that allows for the creation of multiple instances 862A-R called software containers (representing separate user spaces and also called virtualization engines, virtual private servers, or jails) that may each be used to execute a set of one or more applications; in another embodiment the virtualization layer 854 represents a hypervisor (sometimes referred to as a virtual machine monitor (VMM)) or a hypervisor executing on top of a host operating system, and an application is run on top of a guest operating system within an instance 862A-R called a virtual machine (which in some cases may be considered a tightly isolated form of software container) that is run by the hypervisor; in another embodiment, an application is implemented as a unikernel, which can be generated by compiling directly with an application only a limited set of libraries (e.g., from a library operating system (LibOS) including drivers/libraries of OS services) that provide the particular OS services needed by the application, and the unikernel can run directly on hardware 840, directly on a hypervisor represented by virtualization layer 854 (in which case the unikernel is sometimes described as running within a LibOS virtual machine), or in a software container represented by one of instances 862A-R) Again, in embodiments where compute virtualization is used, during operation an instance of the CCP software 850 (illustrated as CCP instance 876A) is executed (e.g., within the instance 862A) on the virtualization layer 854. In embodiments where compute virtualization is not used, the CCP instance 876A is executed, as a unikernel or on top of a host operating system, on the “bare metal” general purpose control plane device 804. The instantiation of the CCP instance 876A, as well as the virtualization layer 854 and instances 862A-R if implemented, are collectively referred to as software instance(s) 852.

In some embodiments, the CCP instance 876A includes a network controller instance 878. The network controller instance 878 includes a centralized reachability and forwarding information module instance 879 (which is a middleware layer providing the context of the network controller 778 to the operating system and communicating with the various NEs), and an CCP application layer 880 (sometimes referred to as an application layer) over the middleware layer (providing the intelligence required for various network operations such as protocols, network situational awareness, and user—interfaces). At a more abstract level, this CCP application layer 880 within the centralized control plane 776 works with virtual network view(s) (logical view(s) of the network) and the middleware layer provides the conversion from the virtual networks to the physical view. Network controller instance 878 can include an optimization coordinator 881 that implements the optimization coordination process described herein. The optimization coordinator 881 can be executed by the processing resources 842 and stored in the non-transitory machine readable media 848.

The centralized control plane 776 transmits relevant messages to the data plane 780 based on CCP application layer 880 calculations and middleware layer mapping for each flow. A flow may be defined as a set of packets whose headers match a given pattern of bits; in this sense, traditional IP forwarding is also flow-based forwarding where the flows are defined by the destination IP address for example; however, in other implementations, the given pattern of bits used for a flow definition may include more fields (e.g., 10 or more) in the packet headers. Different NDs/NEs/VNEs of the data plane 780 may receive different messages, and thus different forwarding information. The data plane 780 processes these messages and programs the appropriate flow information and corresponding actions in the forwarding tables (sometime referred to as flow tables) of the appropriate NE/VNEs, and then the NEs/VNEs map incoming packets to flows represented in the forwarding tables and forward packets based on the matches in the forwarding tables.

Standards such as OpenFlow define the protocols used for the messages, as well as a model for processing the packets. The model for processing packets includes header parsing, packet classification, and making forwarding decisions. Header parsing describes how to interpret a packet based upon a well-known set of protocols. Some protocol fields are used to build a match structure (or key) that will be used in packet classification (e.g., a first key field could be a source media access control (MAC) address, and a second key field could be a destination MAC address).

Packet classification involves executing a lookup in memory to classify the packet by determining which entry (also referred to as a forwarding table entry or flow entry) in the forwarding tables best matches the packet based upon the match structure, or key, of the forwarding table entries. It is possible that many flows represented in the forwarding table entries can correspond/match to a packet; in this case the system is typically configured to determine one forwarding table entry from the many according to a defined scheme (e.g., selecting a first forwarding table entry that is matched). Forwarding table entries include both a specific set of match criteria (a set of values or wildcards, or an indication of what portions of a packet should be compared to a particular value/values/wildcards, as defined by the matching capabilities—for specific fields in the packet header, or for some other packet content), and a set of one or more actions for the data plane to take on receiving a matching packet. For example, an action may be to push a header onto the packet, for the packet using a particular port, flood the packet, or simply drop the packet. Thus, a forwarding table entry for IPv4/IPv6 packets with a particular transmission control protocol (TCP) destination port could contain an action specifying that these packets should be dropped.

Making forwarding decisions and performing actions occurs, based upon the forwarding table entry identified during packet classification, by executing the set of actions identified in the matched forwarding table entry on the packet.

However, when an unknown packet (for example, a “missed packet” or a “match-miss” as used in OpenFlow parlance) arrives at the data plane 780, the packet (or a subset of the packet header and content) is typically forwarded to the centralized control plane 776. The centralized control plane 776 will then program forwarding table entries into the data plane 780 to accommodate packets belonging to the flow of the unknown packet. Once a specific forwarding table entry has been programmed into the data plane 780 by the centralized control plane 776, the next packet with matching credentials will match that forwarding table entry and take the set of actions associated with that matched entry.

A network interface (NI) may be physical or virtual; and in the context of IP, an interface address is an IP address assigned to a NI, be it a physical NI or virtual NI. A virtual NI may be associated with a physical NI, with another virtual interface, or stand on its own (e.g., a loopback interface, a point-to-point protocol interface). A NI (physical or virtual) may be numbered (a NI with an IP address) or unnumbered (a NI without an IP address). A loopback interface (and its loopback address) is a specific type of virtual NI (and IP address) of a NE/VNE (physical or virtual) often used for management purposes, where such an IP address is referred to as the nodal loopback address. The IP address(es) assigned to the NI(s) of a ND are referred to as IP addresses of that ND; at a more granular level, the IP address(es) assigned to NI(s) assigned to a NE/VNE implemented on a ND can be referred to as IP addresses of that NE/VNE.

Next hop selection by the routing system for a given destination may resolve to one path (that is, a routing protocol may generate one next hop on a shortest path); but if the routing system determines there are multiple viable next hops (that is, the routing protocol generated forwarding solution offers more than one next hop on a shortest path—multiple equal cost next hops), some additional criteria is used—for instance, in a connectionless network, Equal Cost Multi Path (ECMP) (also known as Equal Cost Multi Pathing, multipath forwarding and IP multipath) may be used (e.g., typical implementations use as the criteria particular header fields to ensure that the packets of a particular packet flow are always forwarded on the same next hop to preserve packet flow ordering). For purposes of multipath forwarding, a packet flow is defined as a set of packets that share an ordering constraint. As an example, the set of packets in a particular TCP transfer sequence need to arrive in order, else the TCP logic will interpret the out of order delivery as congestion and slow the TCP transfer rate down.

A Layer 3 (L3) Link Aggregation (LAG) link is a link directly connecting two NDs with multiple IP-addressed link paths (each link path is assigned a different IP address), and a load distribution decision across these different link paths is performed at the ND forwarding plane; in which case, a load distribution decision is made between the link paths.

Some NDs include functionality for authentication, authorization, and accounting (AAA) protocols (e.g., RADIUS (Remote Authentication Dial-In User Service), Diameter, and/or TACACS+ (Terminal Access Controller Access Control System Plus). AAA can be provided through a client/server model, where the AAA client is implemented on a ND and the AAA server can be implemented either locally on the ND or on a remote electronic device coupled with the ND. Authentication is the process of identifying and verifying a subscriber. For instance, a subscriber might be identified by a combination of a username and a password or through a unique key. Authorization determines what a subscriber can do after being authenticated, such as gaining access to certain electronic device information resources (e.g., through the use of access control policies). Accounting is recording user activity. By way of a summary example, end user devices may be coupled (e.g., through an access network) through an edge ND (supporting AAA processing) coupled to core NDs coupled to electronic devices implementing servers of service/content providers. AAA processing is performed to identify for a subscriber the subscriber record stored in the AAA server for that subscriber. A subscriber record includes a set of attributes (e.g., subscriber name, password, authentication information, access control information, rate-limiting information, policing information) used during processing of that subscriber's traffic.

Certain NDs (e.g., certain edge NDs) internally represent end user devices (or sometimes customer premise equipment (CPE) such as a residential gateway (e.g., a router, modem)) using subscriber circuits. A subscriber circuit uniquely identifies within the ND a subscriber session and typically exists for the lifetime of the session. Thus, a ND typically allocates a subscriber circuit when the subscriber connects to that ND, and correspondingly de-allocates that subscriber circuit when that subscriber disconnects. Each subscriber session represents a distinguishable flow of packets communicated between the ND and an end user device (or sometimes CPE such as a residential gateway or modem) using a protocol, such as the point-to-point protocol over another protocol (PPPoX) (e.g., where X is Ethernet or Asynchronous Transfer Mode (ATM)), Ethernet, 802.1Q Virtual LAN (VLAN), Internet Protocol, or ATM). A subscriber session can be initiated using a variety of mechanisms (e.g., manual provisioning a dynamic host configuration protocol (DHCP), DHCP/client-less internet protocol service (CLIPS) or Media Access Control (MAC) address tracking). For example, the point-to-point protocol (PPP) is commonly used for digital subscriber line (DSL) services and requires installation of a PPP client that enables the subscriber to enter a username and a password, which in turn may be used to select a subscriber record. When DHCP is used (e.g., for cable modem services), a username typically is not provided; but in such situations other information (e.g., information that includes the MAC address of the hardware in the end user device (or CPE)) is provided. The use of DHCP and CLIPS on the ND captures the MAC addresses and uses these addresses to distinguish subscribers and access their subscriber records.

A virtual circuit (VC), synonymous with virtual connection and virtual channel, is a connection oriented communication service that is delivered by means of packet mode communication. Virtual circuit communication resembles circuit switching, since both are connection oriented, meaning that in both cases data is delivered in correct order, and signaling overhead is required during a connection establishment phase. Virtual circuits may exist at different layers. For example, at layer 4, a connection oriented transport layer datalink protocol such as Transmission Control Protocol (TCP) may rely on a connectionless packet switching network layer protocol such as IP, where different packets may be routed over different paths, and thus be delivered out of order. Where a reliable virtual circuit is established with TCP on top of the underlying unreliable and connectionless IP protocol, the virtual circuit is identified by the source and destination network socket address pair, i.e. the sender and receiver IP address and port number. However, a virtual circuit is possible since TCP includes segment numbering and reordering on the receiver side to prevent out-of-order delivery. Virtual circuits are also possible at Layer 3 (network layer) and Layer 2 (datalink layer); such virtual circuit protocols are based on connection oriented packet switching, meaning that data is always delivered along the same network path, i.e. through the same NEs/VNEs. In such protocols, the packets are not routed individually and complete addressing information is not provided in the header of each data packet; only a small virtual channel identifier (VCI) is required in each packet; and routing information is transferred to the NEs/VNEs during the connection establishment phase; switching only involves looking up the virtual channel identifier in a table rather than analyzing a complete address. Examples of network layer and datalink layer virtual circuit protocols, where data always is delivered over the same path: X.25, where the VC is identified by a virtual channel identifier (VCI); Frame relay, where the VC is identified by a VCI; Asynchronous Transfer Mode (ATM), where the circuit is identified by a virtual path identifier (VPI) and virtual channel identifier (VCI) pair; General Packet Radio Service (GPRS); and Multiprotocol label switching (MPLS), which can be used for IP over virtual circuits (Each circuit is identified by a label).

Certain NDs (e.g., certain edge NDs) use a hierarchy of circuits. The leaf nodes of the hierarchy of circuits are subscriber circuits. The subscriber circuits have parent circuits in the hierarchy that typically represent aggregations of multiple subscriber circuits, and thus the network segments and elements used to provide access network connectivity of those end user devices to the ND. These parent circuits may represent physical or logical aggregations of subscriber circuits (e.g., a virtual local area network (VLAN), a permanent virtual circuit (PVC) (e.g., for Asynchronous Transfer Mode (ATM)), a circuit-group, a channel, a pseudo-wire, a physical NI of the ND, and a link aggregation group). A circuit-group is a virtual construct that allows various sets of circuits to be grouped together for configuration purposes, for example aggregate rate control. A pseudo-wire is an emulation of a layer 2 point-to-point connection-oriented service. A link aggregation group is a virtual construct that merges multiple physical NIs for purposes of bandwidth aggregation and redundancy. Thus, the parent circuits physically or logically encapsulate the subscriber circuits.

Each VNE (e.g., a virtual router, a virtual bridge (which may act as a virtual switch instance in a Virtual Private LAN Service (VPLS) is typically independently administrable. For example, in the case of multiple virtual routers, each of the virtual routers may share system resources but is separate from the other virtual routers regarding its management domain, AAA (authentication, authorization, and accounting) name space, IP address, and routing database(s). Multiple VNEs may be employed in an edge ND to provide direct network access and/or different classes of services for subscribers of service and/or content providers.

Within certain NDs, “interfaces” that are independent of physical NIs may be configured as part of the VNEs to provide higher-layer protocol and service information (e.g., Layer 3 addressing). The subscriber records in the AAA server identify, in addition to the other subscriber configuration requirements, to which context (e.g., which of the VNEs/NEs) the corresponding subscribers should be bound within the ND. As used herein, a binding forms an association between a physical entity (e.g., physical NI, channel) or a logical entity (e.g., circuit such as a subscriber circuit or logical circuit (a set of one or more subscriber circuits)) and a context's interface over which network protocols (e.g., routing protocols, bridging protocols) are configured for that context. Subscriber data flows on the physical entity when some higher-layer protocol interface is configured and associated with that physical entity.

Some NDs provide support for implementing VPNs (Virtual Private Networks) (e.g., Layer 2 VPNs and/or Layer 3 VPNs). For example, the ND where a provider's network and a customer's network are coupled are respectively referred to as PEs (Provider Edge) and CEs (Customer Edge). In a Layer 2 VPN, forwarding typically is performed on the CE(s) on either end of the VPN and traffic is sent across the network (e.g., through one or more PEs coupled by other NDs). Layer 2 circuits are configured between the CEs and PEs (e.g., an Ethernet port, an ATM permanent virtual circuit (PVC), a Frame Relay PVC). In a Layer 3 VPN, routing typically is performed by the PEs. By way of example, an edge ND that supports multiple VNEs may be deployed as a PE; and a VNE may be configured with a VPN protocol, and thus that VNE is referred as a VPN VNE.

Some NDs provide support for VPLS (Virtual Private LAN Service). For example, in a VPLS network, end user devices access content/services provided through the VPLS network by coupling to CEs, which are coupled through PEs coupled by other NDs. VPLS networks can be used for implementing triple play network applications (e.g., data applications (e.g., high-speed Internet access), video applications (e.g., television service such as IPTV (Internet Protocol Television), VoD (Video-on-Demand) service), and voice applications (e.g., VoIP (Voice over Internet Protocol) service)), VPN services, etc. VPLS is a type of layer 2 VPN that can be used for multi-point connectivity. VPLS networks also allow end use devices that are coupled with CEs at separate geographical locations to communicate with each other across a Wide Area Network (WAN) as if they were directly attached to each other in a Local Area Network (LAN) (referred to as an emulated LAN).

In VPLS networks, each CE typically attaches, possibly through an access network (wired and/or wireless), to a bridge module of a PE via an attachment circuit (e.g., a virtual link or connection between the CE and the PE). The bridge module of the PE attaches to an emulated LAN through an emulated LAN interface. Each bridge module acts as a “Virtual Switch Instance” (VSI) by maintaining a forwarding table that maps MAC addresses to pseudowires and attachment circuits. PEs forward frames (received from CEs) to destinations (e.g., other CEs, other PEs) based on the MAC destination address field included in those frames.

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

1. A method of a node in a radio access network, the method to optimize radio access network operations, the method comprising:
determining a topology of the radio access network;
exchanging optimization information and network metric information with neighbor nodes in the topology;
determining an updated local configuration for the node based on a negotiated optimization with the neighbor nodes; and
updating an optimization function based on collected updated network metric information of the node executing the updated local configuration.

2. The method of claim 1, further comprising:
discovering the neighbor nodes in the radio access network using any one or more of geographic neighbor relations, radiation patterns, automatic neighbor relations, or information from a network planning tool.

3. The method of claim 1, further comprising:
initializing at least one optimization function that evaluates local configuration of the node for a predicted network metric.

4. The method of claim 1, further comprising:
implementing the updated local configuration; and
collecting updated network metric information for the node implementing the update local configuration.

5. The method of claim 1, further comprising:
transferring pretrained optimization functions to another node in another radio access network.

6. A network device functioning as a part of a node in a radio access network, the network device to optimize radio access network operations, the network device comprising:
a non-transitory machine-readable storage medium having stored therein an optimization coordinator; and
a processor coupled to the non-transitory machine-readable storage medium, the processor to execute the optimization coordinator, the optimization coordinator to determine a topology of the radio access network, to exchange optimization information and network metric information with neighbor nodes in the topology, to determine an updated local configuration for the node based on a negotiated optimization with the neighbor nodes, and to update an optimization function based on collected updated network metric information of the node executing the updated local configuration.

7. The network device of claim 6, wherein the optimization coordinator is further to discover the neighbor nodes in the radio access network using any one or more of geographic neighbor relations, radiation patterns, automatic neighbor relations, or information from a network planning tool.

8. The network device of claim 6, wherein the optimization coordinator is further to initialize at least one optimization function that evaluates local configuration of the node for a predicted network metric.

9. The network device of claim 6, wherein the optimization coordinator is further to implement the updated local configuration, and collect updated network metric information for the node implementing the update local configuration.

10. The network device of claim 6, wherein the optimization coordinator is further to transfer pretrained optimization functions to another node in another radio access network.

11. An electronic device functioning as a part of a node in communication with a radio access network, the electronic device to implement a plurality of virtual machines that support network function virtualization (NFV), the plurality of virtual machines to execute a method to optimize radio access network operations, the electronic device comprising:
a non-transitory machine-readable storage medium having stored therein a optimization coordinator; and
a processor coupled to the non-transitory machine-readable storage medium, the processor to execute at least one of the plurality of virtual machines, the at least one of the plurality of virtual machines to execute the optimization coordinator, the optimization coordinator to determine a topology of the radio access network, to exchange optimization information and network metric information with neighbor nodes in the topology, to determine an updated local configuration for the node based on a negotiated optimization with the neighbor nodes, and to update an optimization function based on collected updated network metric information of the node executing the updated local configuration.

12. The electronic device of claim 11, wherein the optimization coordinator is further to discover the neighbor nodes in the radio access network using any one or more of geographic neighbor relations, radiation patterns, automatic neighbor relations, or information from a network planning tool.

13. The electronic device of claim 11, wherein the optimization coordinator is further to initialize at least one optimization function that evaluates local configuration of the node for a predicted network metric.

14. The electronic device of claim 11, wherein the optimization coordinator is further to implement the updated local configuration, and collect updated network metric information for the node implementing the update local configuration.

15. The electronic device of claim 11, wherein the optimization coordinator is further to transfer pretrained optimization functions to another node in another radio access network.

16. An electronic device in a cloud computing environment, the electronic device to implement functions to support a node managing configuration of devices in a radio access network, the electronic device to optimize radio access network operations, the electronic device comprising:
a non-transitory machine-readable storage medium having stored therein a optimization coordinator; and
a processor coupled to the non-transitory machine-readable storage medium, the processor to execute the optimization coordinator, the optimization coordinator to determine a topology of the radio access network, to exchange optimization information and network metric information with neighbor nodes in the topology, to determine an updated local configuration for the node based on a negotiated optimization with the neighbor nodes, and to update an optimization function based on collected updated network metric information of the node executing the updated local configuration.

17. The electronic device of claim 16, wherein the optimization coordinator is further to discover the neighbor nodes in the radio access network using any one or more of geographic neighbor relations, radiation patterns, automatic neighbor relations, or information from a network planning tool.

18. The electronic device of claim 16, wherein the optimization coordinator is further to initialize at least one optimization function that evaluates local configuration of the node for a predicted network metric.

19. The electronic device of claim 16, wherein the optimization coordinator is further to implement the updated local configuration, and collect updated network metric information for the node implementing the update local configuration.

20. The electronic device of claim 16, wherein the optimization coordinator is further to transfer pretrained optimization functions to another node in another radio access network.
